(19) United States
(12) Patent Application Publication
(10) Pub. No.: US 2001/0048400 A1
(43) Pub. Date: Dec. 6, 2001

(54) Low profile, broadband, dual mode, modified notch antenna

(76) Inventors: Donald G. LaRochelle, Tyngsboro, MA (US); Micheal J. O'Brien, Nashua, NH (US)

Correspondence Address: Vernon C. Maine, Maine and Asmus, 100 Main Street, Nashua, NH, 03060, US

(21) Appl. No.: 09/847,551

(22) Filed: May 2, 2001

Related U.S. Application Data
(60) Provisional application No. 60/201,219, filed on May 2, 2000.

(51) Int. Cl. H01Q 13/10; H01Q 9/28

(52) U.S. Cl. 343/795; 343/770; 343/767

(57) ABSTRACT

A low profile, broadband includes an active conductive edge having a shape which approximates a quadratic curve. Two identical elements may be used in an opposed manner to form signals across their respective active edges, and two pairs of opposed identical elements may be used in quadrature for handling circularly polarized signals with a high degree of polarization purity. The quadratic curvature of the elements can provide sufficient space to co-locate a second, smaller antenna within the same volume and aperture as the larger antenna. Applications include combinations of a wide variety of current communications systems.

### RELATED APPLICATIONS

This application claims priority to United States Provisional Patent Application Serial No. 60/201,219, filed May 2, 2000.

### FIELD OF THE INVENTION

The present invention relates to notch antennas and, more specifically, to a notch antenna suitable for circularly polarized signals.

### BACKGROUND OF THE INVENTION

Antennas for line-of-sight (LOS) communications applications, typically in the UHF or L-band frequency bands, often have differing gain, polarization and field of view (FOV) requirements. Applications such as satellite communications (SATCOM) also impose stringent limitations on antenna size, volume and weight. Ideally, antennas for these types of applications should have reasonable gain at the horizon while still providing good coverage throughout the remainder of the hemisphere.

Typical antennas of the prior art suitable for use in these applications generally require large cavities having absorbers behind the radiating elements and suffer from low gain because of a 3 dB signal loss to the cavity. Applications benefiting from better antennas (i.e., higher gain, smaller, lighter, etc.) include SATCOM, GPS, Joint Tactical Information Distribution System (JTIDS), cellular phone, Tactical Air Navigation (TACAN), 1FF transponder and digital Personal Communications Systems (PCS). Further complicating matters is the fact that several of these systems are frequently co-located on vehicles and particularly airplanes, which further drives the need for aperture and volumetric efficiency. Also, circular polarization is generally required for SATCOM and GPS applications, and polarization purity is critical for communication applications utilizing frequency reuse by means of polarization diversity.

It is, therefore, an object of the invention to provide an antenna which is capable of both linear and circular polarization.

It is an additional object of the invention to provide such an antenna having high polarization purity for circularly polarized signals.

It is another object of the invention to provide a modified notch antenna capable of performing these objectives.

It is still another object of the invention to provide a modified notch antenna which is nestable within itself at a smaller size for simultaneously accessing a higher frequency band using the same aperture and volume.

### SUMMARY OF THE INVENTION

The present invention features both a low profile, broadband antenna as well as a notch antenna with a unique signal feed. The broadband antenna includes an active conductive edge having a shape which approximates a quadratic curve. Two identical elements may be used in an opposed manner to form signals across their respective active edges, and two pairs of opposed identical elements may be used in quadrature for handling circularly polarized signals with a high degree of polarization purity. The quadratic curvature of the elements can provide sufficient space to co-locate a second, smaller antenna within the same volume and aperture as the larger antenna.

In another form, a notch antenna includes a slot formed between the active conductive element and ground, which slot is used for coupling signals through the antenna. This arrangement can be used in quadrature to provide circularly polarized signals with high polarization purity.

### BRIEF DESCRIPTION OF THE DRAWINGS

A complete understanding of the present invention may be obtained by reference to the accompanying drawings, when considered in conjunction with the subsequent detailed description, in which:

FIG. 1 is a perspective view of the low profile, broadband dual mode modified notch antenna constructed in accordance with one embodiment of the present invention; and

FIG. 2 is a side view of an antenna constructed in accordance with another embodiment of the present invention.

### DETAILED DESCRIPTION OF THE DRAWINGS

The present application discloses a broadband, low profile, dual mode modified notch antenna as well as a unique slot feed arrangement for notch antennas in general.

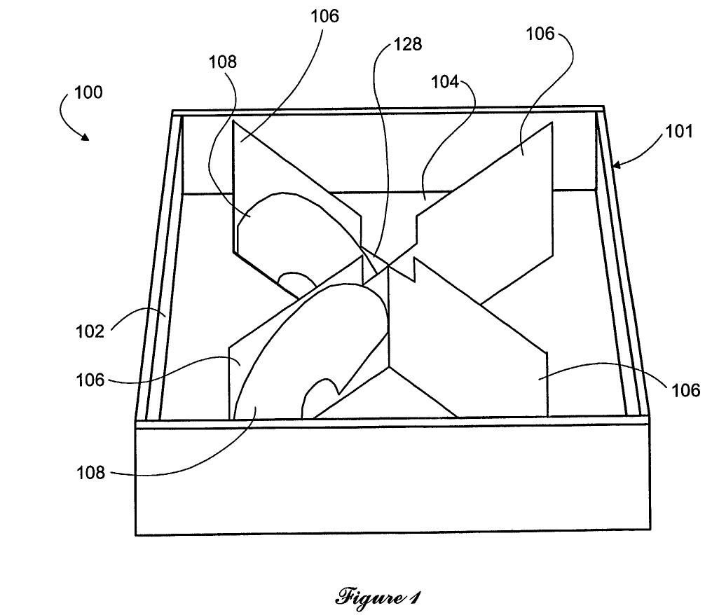

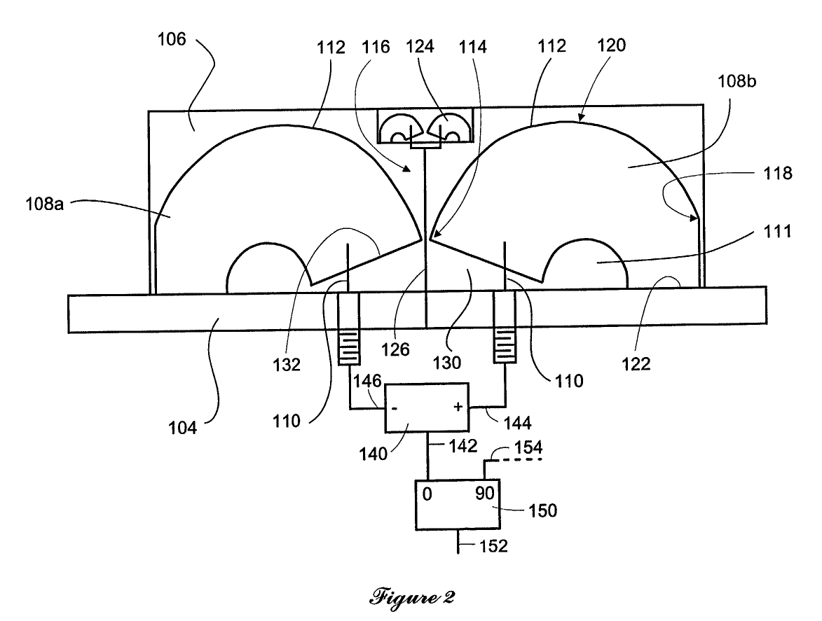

FIGS. 1 and 2 are referred to herein simultaneously unless otherwise specified. Identical and mirror components appearing in both figures bear the same reference numbers, and any singular description of such components herein is intended to refer to all such identical and mirrored components unless otherwise specified.

FIG. 1 shows an entire notch antenna 100 located in a cavity, including a ground plane 104 and four identical members 106 oriented orthogonally with respect to each other and with respect to ground plane 104. A cavity enclosure 101 surrounds antenna 100 including four identical walls 102. Each of the members 106 includes a conductive element 108 formed thereon.

Conductive elements 108 form the active elements of the antenna. They are each fed with a separate coaxial feed 110, which extends through the ground plane 104. Each conductive element 108 includes an active edge 112, which is operative in combination with another conductor to radiate and receive electromagnetic signals. In one embodiment of the inventions described herein the active edges 112 have a shape which approximates a quadratic curve. The active edges start from a point 114 and extend away from the ground plane 104. As shown in FIG. 2, a pair of opposed conductive elements 108 have the starting points 114 of their active edges 108 located proximally to each other, and from there the active edges 112 extend away from each other and away from ground plane 104. These opposed active edges 112 collectively form the active notch 116 of the antenna.

The curvature of active edges 114, and even of one edge alone, provides antenna 100 with its bandwidth, such that, in one mode of operation, electromagnetic signals are launched and received by the notch 116 at a position along the active edge 112 which is a function of the wavelength of the particular signal. This holds true as the wavelength increases and the distance between corresponding points of the active edges grows larger.

As mentioned, the shape of active edges 112, approximates a quadratic curve, such as a circle. This higher power of curvature provides a great deal of separation between corresponding points of the active edges 112 and thus a higher degree of bandwidth. Quadratic curves also curve back on themselves as shown, such that the active edges 112 actually extend back towards the ground plane 104 as they approach their respective distal points 118. In this manner the present notch antenna provides the aforesaid high degree of bandwidth, without the necessity for a correspondingly larger height profile for the antenna. Thus the bandwidth is extended by some fraction thereof from the highest point 120 of active edge 112 without any increase in the height profile of the antenna 100. It should be noted that the active edge 112 does not have to be constrained by the distal end 118 as shown, but may in fact extend to the ground plane. Conductive elements 108 are connected to ground plane 104 along the horizontal edge 122 thereof.

As a further benefit of the quadratic curvature of active edges 112, the large amount of spacing provided between opposed edges is sufficient to allow location of a second, smaller antenna 124, therebetween. FIG. 2 shows antenna 124 as a smaller version of the antenna 100, however, any suitable antenna may be used. It is only necessary that antenna 124 be sufficiently smaller so that dimensions thereof do not interfere with signals of the shortest wavelength of operation of antenna 100. Antenna 124 is shown with a signal feed 126 passing up through the center of antenna 100. Because the feed 126 is positioned perpendicular to the E and H fields generated between conductive elements 108, it does not interfere with those signals. FIG. 1 simply shows a notch 128 formed in members 106 where the antenna 124 can be located.

Conductive elements 108 are used in opposed pairs 108a, 108b as indicated in FIG. 2, so that their active edges 112 are opposed for forming or capturing transmission signals therebetween, and their respective starting points 114 are proximally located. As mentioned, members 106 of FIG. 1 are arranged orthogonally to each other such that two pairs of opposed conductive elements 108 are formed, with the two pairs being orthogonal to each other. In this manner, the two pairs may be fed with quadrature signals for the purpose of producing circularly polarized signals. These circularly polarized signals are first formed between the opposed conductive elements 108 at the starting points 114 of the active edges 112. For this reason, these starting points are located proximally to each other and may be referred to as proximal points. Proximal or starting points 114 are also all located equidistant from ground plane 104, as are corresponding points on the identical, opposed active edges 112.

Conductive elements 108 also include a unique feed arrangement in the form of slots 130. Each conductive element 108 includes an edge 132, which begins at the respective starting point 114 and extends along ground plane 104. Edge 132 forms an angle with ground plane 104 which thereby tapers slot 130 with an increasing dimension between the feed 110 and starting point 114. This taper provides an increasing impedance for signals created across slot 130 as they travel towards starting point 114. Likewise, slot 130 continues its diminishing taper until it reaches a broadband slot termination 111, which provides a matching terminal impedance. The use of such slots 130 is considered to be unique and particularly for providing signals to notch antennas as shown.

A particularly useful combination of the aforesaid elements is the use of slots for feeding signals to a quadrature notch antenna. This combination allows accurate phase alignment of circularly polarized signals, providing these signals with a high degree of polarization purity. Although the precise phase center will vary according to wavelength, it will be located along the center axis of antenna 100. The alignment of phase centers between the orthogonal pairs of elements is provided by the proximity of the proximal or starting points 114. Their equal distance to ground plane 104, which is part of the slots 130, contributes to the phase alignment of the quadrature signals.

As mentioned, the conductive elements 108 are formed on members 106, by any suitable means. In one form, members 106 are made of a dielectric material such as Duroid and conductive elements 108 are formed thereon by printed circuit techniques. Two opposing members 106 may also be formed from the same piece of dielectric material and the conductive elements 108 may be formed on the same side of that dielectric material as shown in FIG. 2, or they may be formed on opposing sides of that dielectric material as shown in FIG. 1.

The antennas of the present application may be energized in a variety of modes and orientations. These modes can vary between horizontal and vertical orientations because the antennas may be positioned either vertically or horizontally. Although the operational modes are described herein with respect to transmission signals the same modes of operation apply to received signals and may thus be referred to as modes of coupling signals through the antennas.

One mode of operation is the monopole mode, which may be created by driving conductive elements 108 equally and in phase with respect to ground plane 104. In this mode signals are launched and received at a point along the active edge which point is a function of the wavelength of the particular signal. Likewise, when all conductive elements 108 are arranged as shown in FIG. 1, coupling the same signal to each of the conductive elements causes them to all operate in the monopole mode with respect to ground plane 104. Vertical, as opposed to horizontal, orientation of ground plane 104 provides horizontally, as opposed to vertically, polarized signals.

A more significant mode of operation of the present antennas is provided by coupling signals across the feeds 110 of opposed conductive elements 108a and 108b of FIG. 2. For this purpose, a signal splitter 140 is shown to couple signals received on an input line 142 to a pair of out of phase output lines 144, 146, respectively. In this manner, input signals are provided between opposed conductive elements 108a, 108b for energizing notch 116. Signals introduced in this manner are first formed across their respective slots 130 with respect to ground and travel there-along to the proximal or starting points 114. At the proximal or starting points 114, these signals transition to the notch 116 and form an E field between active edges 112. These E fields then travel along the notch 116 until they transition to transmission signals at a point along active edges 112, which point is a function of the wavelength of the particular signal. This mode of operation of an opposed pair of conductive elements 108a, 108b is used to handle horizontally polarized signals when ground plane 104 is horizontally oriented and is alternatively used to handle vertically polarized signals when ground plane 104 is vertically oriented.

A further operating mode for the antennas is that of circular polarization. This mode is produced by coupling signals through the orthogonally oriented elements of FIG. 1. As described, the conductive elements 108 operate in opposed pairs in the same manner described above in reference to FIG. 2. Each of the opposed pairs is fed the quadrature signal of the other. For this purpose a quadrature splitter 150 is shown in FIG. 2 having an input 152 for receiving a transmission signal, a reference signal output connected to the input 142 of splitter 140 and a quadrature signal output 154 for coupling a quadrature version of the input signal to the second pair of opposed conductive elements 108. This second pair of opposed conductive elements 108 receives its quadrature signal in the same manner as elements 108a, 108b, through a respective spitter (not shown) which is identical to splitter 140. Under this arrangement the quadrature signals transition to their respective notches at the same point in space, thereby providing accurate phase alignment to both the E and H fields of the circularly polarized signal. This results in a circularly polarized signal with a high degree of polarization purity.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A broadband antenna, comprising:
a pair of conductive elements; and
a first conductive element of the pair having an active edge adapted to handle electromagnetic signals with respect to a second conductive element of the pair,
wherein the active edge has a shape which approximates a quadratic curve.

2. The antenna of claim 1, wherein the second conductive element has an active edge which defines a notch antenna in relation to the active edge of the first conductive element.

3. The antenna of claim 2, wherein the first and second conductive elements are substantially identical.

4. The antenna of claim 3, wherein the active edges of the first and second conductive elements extend from a respective proximal point relative to each other.

5. The antenna of claim 4, wherein the active edges define a space therebetween, and further comprising a second antenna substantially smaller than the previously defined antenna of the parent claims hereof, said second antenna being located in the space defined between the active edges.

6. The antenna of claim 4, further comprising a ground plane coupled to each of the conducting elements, wherein the active edges extend away from the ground plane from their respective proximal points.

7. The antenna of claim 6, wherein the first and second conductive elements have respective distal points along their active edges, and further wherein the active edges extend toward the ground plane approaching their respective distal points.

8. The antenna of claim 6, wherein the conductive elements are planar.

9. The antenna of claim 8, wherein the conductive elements are substantially located in a common plane.

10. The antenna of claim 9, wherein the common plane of the conductive elements is substantially perpendicular to the ground plane.

11. The antenna of claim 10, further comprising a second pair of conductive elements which are identical and perpendicular to the first said pair of conductive elements, wherein the conductive elements of the second pair are located in a second common plane perpendicular to the ground plane and have respective proximal points located proximally to the proximal points of the first pair of conductive elements.

12. The antenna of claim 11, wherein the active edges of both pairs of conductive elements define a space therebetween, and further comprising a second antenna substantially smaller than the previously defined antenna of the parent claims hereof, said second antenna being located in the space defined between the active edges.

13. The antenna of claim 11, further comprising a cavity defined by conductive walls located around the conductive elements and perpendicular to the ground plane.

14. The antenna of claim 1, wherein the second conductive element is a ground plane and the active edge of the first conductive element extends, from a starting point, in a direction away from the ground plane.

15. The antenna of claim 14, wherein the first conductive element has a second edge extending from the starting point and along the ground plane to form a slot therebetween, and further comprising a signal feed extending from the ground plane and across the slot.

16. The antenna of claim 15, wherein the slot has an increasing taper from the signal feed to the starting point.

17. The antenna of claim 16, wherein the slot includes a broadband impedance matched termination, and further wherein the slot extends with a decreasing taper from the signal feed to the termination.

18. A notch antenna, comprising:
a ground plane;
a pair of conductive elements, each having an active edge and being adapted to handle electromagnetic signals between their respective active edges;
wherein the active edges of the first and second conductive elements extend from a respective proximal point relative to each other and away from the ground plane;
further wherein each conductive element includes a second edge extending from its respective proximal point and along the ground plane to form a slot therebetween; and
a separate signal feed for each conductive element extending from the ground plane and across the respective slot.

19. The notch antenna of claim 18, wherein each slot has an increasing taper from its respective signal feed to its respective proximal point.

20. The notch antenna of claim 19, wherein each slot includes a respective impedance matched termination, and further wherein each slot extends with a decreasing taper from its respective signal feed to its respective termination.

21. The notch antenna of claim 18, further comprising means for coupling signals between the respective signal feeds of the conductive elements;
wherein the conductive elements are adapted, at their proximal points, to transition signals carried across their respect slots in relation to ground, into signals carried between their respective active edges and vice versa.

22. The notch antenna of claim 21, wherein a transmission signal introduced across the respective signal feeds is injected into the respective slots of the conductive elements with respect to the ground plane and travels to the respective proximal points of each conductive element, whereupon it transitions to a signal between the respective active edges of the conductive elements.

23. The notch antenna of claim 21, wherein transmission signals received between the active edges are transitioned at the proximal point into the respective slots with respect to ground for presentation as a received signal across the signal feeds.

24. The notch antenna of claim 21, further comprising a second pair of conductive elements identical to the first said pair of conductive elements and having respective active edges which are located orthogonally with respect to the active edges of the first said pair of conductive elements, wherein the proximal points of all of the conductive elements are proximal to each other and located substantially equidistant from the ground plane.

25. The notch antenna of claim 24, further comprising circuit means for handling quadrature signals between the first said and second pairs of conductive elements, wherein circularly polarized signals are accurately transitioned at the proximal points.

26. The notch antenna of claim 24, wherein each active edge has a shape which approximates a quadratic curve.

27. The antenna of claim 26, wherein the first and second conductive elements have respective distal points along their active edges, and further wherein the active edges extend toward the ground plane approaching their respective distal points.

28. The antenna of claim 25, wherein the conductive elements of each pair are planar and substantially located in a respective common plane, and further wherein the respective common planes are orthogonally positioned with respect to each other and with respect to the ground plane.

29. The antenna of claim 28, wherein the active edges define a space therebetween, and further comprising a second antenna substantially smaller than the previously defined antenna of the parent claims hereof, said second antenna being located in the space defined between the active edges.

30. The antenna of claim 29, wherein the second antenna is substantially identical to the previously defined antenna except for the claimed size difference.

31. The notch antenna of claim 18, further comprising a second pair of conductive elements identical to the first said pair of conductive elements and having respective active edges which are located orthogonally with respect to the active edges of the first said pair of conductive elements, wherein the proximal points of all of the conductive elements are proximal to each other and located substantially equidistant from the ground plane.
